(19) United States
(12) Patent Application Publication
(10) Pub. No.: US 2026/0264583 A1
(43) Pub. Date: Sep. 10, 2026

(54) SEAT WITH LIFT OUT CARRIER

(71) Applicant: Wonderland Switzerland AG, Steinhausen (CH)

(72) Inventors: David A. Lehman, Lancaster, PA (US); Patrick J. G. Bowers, West Chester, PA (US); Joshua Ferguson, Southampton, PA (US); Andrew J. Taylor, Mohnton, PA (US); Curtis M. Hartenstine, Birdsboro, PA (US)

(21) Appl. No.: 19/163,328

(22) PCT Filed: Mar. 7, 2024
(86) PCT No.: PCT/US2024/018853

§ 371 Date: Sep. 8, 2025

Related U.S. Application Data
(60) Provisional application No. 63/489,570, filed on Mar. 10, 2023.

(51) Int. Cl. B60N 2/28; B60N 3/00; B60N 3/10

(52) U.S. Cl. CPC B60N 2/2821; B60N 2/2812; B60N 2/2845; B60N 2/2851; B60N 2/2869; B60N 2/2872; B60N 3/002; B60N 3/102; B60N 2/2875

(57) ABSTRACT

A child safety seat for placement on a vehicle seat includes a seat base and a seat body associable with said seat base. The seat body is configurable as both an infant seat and a toddler seat. A restraint harness is associated with the seat body and is operable when the seat body is configured as both the infant seat and the toddler seat.

### CROSS REFERENCE TO RELATED APPLICATIONS

This application claims the benefit of U.S. Application No. 63/489,570, filed on Mar. 10, 2023, which is incorporated herein by reference in its entirety.

### BACKGROUND

Exemplary embodiments of the disclosure relative to child safety seats for use in a vehicle.

A child safety seat is used to transport children and is typically designed for use in an automobile vehicle to properly restrain a child in the event of accident. Some infant carriers are designed not only to form part of the child safety seat within a vehicle, but also to attach to a stroller to form a travel system. The use of such a carrier allows the child to be positioned within and properly restrained within the carrier while the carrier is separated from the vehicle. However, such a system is not suitable for use with larger children.

Therefore, there is a need for an improved child safety seat that allows not only for easy transport of the child when separated from the vehicle seat, but also for use with both infants and toddlers.

### BRIEF DESCRIPTION

According to an embodiment, a child safety seat for placement on a vehicle seat includes a seat base and a seat body associable with said seat base. The seat body is configurable as both an infant seat and a toddler seat. A restraint harness is associated with the seat body and is operable when the seat body is configured as both the infant seat and the toddler seat.

In addition to one or more of the features described above, or as an alternative, in further embodiments the seat body further includes a seat shell affixed to the seat base and a seat insert removably connectable to said seat shell.

In addition to one or more of the features described above, or as an alternative, in further embodiments the restraint harness is affixed to the seat insert.

In addition to one or more of the features described above, or as an alternative, in further embodiments the seat insert is separable from the seat shell when the child is coupled to the seat insert by the restraint harness.

In addition to one or more of the features described above, or as an alternative, in further embodiments the seat insert further includes a headrest. The headrest is movable between a first position associated with the infant seat and a second position associated with the toddler seat.

In addition to one or more of the features described above, or as an alternative, in further embodiments the restraint harness is operably coupled to the headrest.

In addition to one or more of the features described above, or as an alternative, in further embodiments the seat insert further comprises a body including an insert seat portion and an insert upright portion and at least one sidewall. The at least one sidewall is connectable to a side of said body.

In addition to one or more of the features described above, or as an alternative, in further embodiments when the seat body is configured as the infant seat, the at least one sidewall is connected to the body and when the seat body is configured as the toddler seat, the at least one sidewall is separated from the body.

In addition to one or more of the features described above, or as an alternative, in further embodiments the seat body further includes an insert seat support surface on the seat insert for supporting a child thereon and a carrying handle rotatably connected to the seat insert. The carrying handle is rotatable between a carrying position and a stored position. In the stored position, the carrying handle is positioned below the insert seat support surface.

In addition to one or more of the features described above, or as an alternative, in further embodiments the seat body is positionable relative to the seat base in both a forward-facing position and a rearward-facing position.

In addition to one or more of the features described above, or as an alternative, in further embodiments the seat body is positionable relative to the seat base at a position between the forward-facing position and the rearward-facing position.

According to an embodiment, an infant seat of a child safety seat includes a seat body having a seat shell and a seat insert removably connectable to the seat shell. The seat insert has a body and a restraint harness coupled to the body.

In addition to one or more of the features described above, or as an alternative, in further embodiments the seat shell further includes a cavity and the seat insert is positionable within the cavity.

In addition to one or more of the features described above, or as an alternative, in further embodiments the insert further includes a plurality of sidewalls connected to the body to define an insert cavity within which a child is receivable.

In addition to one or more of the features described above, or as an alternative, in further embodiments the body and the plurality of sidewalls of the infant seat are positionable within the cavity.

In addition to one or more of the features described above, or as an alternative, in further embodiments the seat insert is separable from the seat shell when the child is coupled to the seat insert by the restraint harness.

In addition to one or more of the features described above, or as an alternative, in further embodiments the seat insert is an infant carrier when separated from the seat shell.

In addition to one or more of the features described above, or as an alternative, in further embodiments the seat insert is transformable to a toddler configuration.

According to an embodiment, a toddler seat of a child safety seat includes a seat body having a seat shell and a seat insert removably connectable to the seat shell. The seat insert has a body and a restraint harness coupled to the body.

In addition to one or more of the features described above, or as an alternative, in further embodiments the seat shell further includes a cavity and the seat insert is positionable within the cavity.

In addition to one or more of the features described above, or as an alternative, in further embodiments the seat insert further includes a plurality of sidewalls removably connectable to the body. The plurality of sidewalls are separated from the body.

In addition to one or more of the features described above, or as an alternative, in further embodiments the seat insert is separable from the seat shell when a child is coupled to the seat insert by the restraint harness.

In addition to one or more of the features described above, or as an alternative, in further embodiments the seat insert is transformable to an infant configuration.

According to an embodiment, a method of operating a child safety seat includes positioning a seat shell relative to a seat base, arranging a seat insert in one of an infant configuration and a toddler configuration, and connecting the seat insert to the seat shell.

In addition to one or more of the features described above, or as an alternative, in further embodiments positioning the seat shell relative to the seat base includes rotating the seat shell between a forward-facing position and a rearward-facing position.

In addition to one or more of the features described above, or as an alternative, in further embodiments arranging the seat insert includes adjusting a position of a headrest of the seat insert. In the infant configuration, the headrest is lowered relative to the seat insert and in the toddler configuration, the headrest is raised relative to the seat insert.

In addition to one or more of the features described above, or as an alternative, in further embodiments arranging the seat insert includes adjusting a position of at least one sidewall of the seat insert, wherein in the infant configuration, the at least one sidewall is attached to the seat insert and in the toddler configuration, the at least one sidewall is separated from the seat insert.

In addition to one or more of the features described above, or as an alternative, in further embodiments including coupling a child to the seat insert via a restraint harness of said seat insert.

In addition to one or more of the features described above, or as an alternative, in further embodiments the restraint harness is operable to couple the child to the seat insert when the seat insert is in both the infant configuration and the toddler configuration.

In addition to one or more of the features described above, or as an alternative, in further embodiments connecting the seat insert to the seat shell includes positioning the seat insert within a cavity of the seat shell.

In addition to one or more of the features described above, or as an alternative, in further embodiments connecting the seat insert to the seat shell includes connecting a first portion of a coupling mechanism mounted to the seat insert to a complementary second portion of the coupling mechanism mounted to the seat shell.

In addition to one or more of the features described above, or as an alternative, in further embodiments including adjusting a position of a carrying handle of said seat insert.

In addition to one or more of the features described above, or as an alternative, in further embodiments adjusting the position of the carrying handle includes rotating the carrying handle about an axis relative to the seat insert.

In addition to one or more of the features described above, or as an alternative, in further embodiments adjusting the position of the carrying handle includes separating the carrying handle from the seat insert.

According to an embodiment, a child safety seat for placement on a vehicle seat, includes a seat base, a seat body associated with the seat base, and an accessory associated with one of the seat base and the seat body. The accessory is transformable between a retracted configuration and an extended configuration. In the retracted configuration, the accessory is stowed within a pocket formed in one of the seat base and the seat body.

In addition to one or more of the features described above, or as an alternative, in further embodiments the accessory is pivotable about an axis between the retracted configuration and the extended configuration.

In addition to one or more of the features described above, or as an alternative, in further embodiments the accessory is translatable between the retracted configuration and the extended configuration.

In addition to one or more of the features described above, or as an alternative, in further embodiments the accessory includes a tray having a recessed area formed therein.

In addition to one or more of the features described above, or as an alternative, in further embodiments the accessory includes a cup holder.

In addition to one or more of the features described above, or as an alternative, in further embodiments in the retracted configuration, the accessory is substantially flush with an adjacent surface of one of the seat base and the seat body.

### BRIEF DESCRIPTION OF THE DRAWINGS

The following descriptions should not be considered limiting in any way. With reference to the accompanying drawings, like elements are numbered alike:

FIG. 1A is a perspective view of a child safety seat including an infant seat in a rearward-facing configuration according to an embodiment;

FIG. 1B is a perspective view of a child safety seat including an infant seat in a forward-facing configuration according to an embodiment;

FIG. 2 is a perspective view of a child safety seat including an infant seat in a side-facing configuration according to an embodiment;

FIG. 3A is a perspective view of a child safety seat including a toddler seat in a rearward-facing configuration according to an embodiment;

FIG. 3B is a perspective view of a child safety seat including a toddler seat in a forward-facing configuration according to an embodiment;

FIG. 4A is a perspective view of an insert of the child safety seat having a carrying handle in a carrying position according to an embodiment;

FIG. 4B is a perspective view of the insert of the child safety seat of FIG. 5A having a carrying handle in a rearwardly reclined position according to an embodiment;

FIG. 5A is a side perspective view of an insert of the child safety seat in an infant configuration according to an embodiment;

FIG. 5B is a front perspective view of the insert of the child safety seat of FIG. 5A according to an embodiment;

FIG. 6 is a perspective view of a seat body of the child safety seat when the insert is separated from the seat shell according to an embodiment;

FIG. 7A is a perspective view of the seat body of the child safety seat when the insert is installed within the seat shell and the carrying handle is in a carrying position according to an embodiment;

FIG. 7B is a perspective view of the seat body of the child safety seat when the insert is installed within the seat shell and the carrying handle is in a forwardly angled position according to an embodiment;

FIG. 8 is a perspective view of the seat body of the child safety seat when the insert is installed within the seat shell and the carrying handle separated from the insert according to an embodiment;

FIG. 9 is a perspective view of the carrying handle stowed within the cavity of the seat shell according to an embodiment;

FIG. 10A is a perspective view of a flexible region of the carrying handle of the insert according to an embodiment;

FIG. 10B is a detailed perspective view of the flexible region of FIG. 10A according to an embodiment;

FIG. 11 is a perspective view of a child safety seat having a stowable accessory according to an embodiment;

FIG. 12 is a front perspective view of a seat shell of a child safety seat according to an embodiment;

FIG. 13 is a rear perspective view of an insert of a child safety seat according to an embodiment;

FIG. 14 is a cross-sectional view taken through the shell upright portion 42 of the seat shell according to an embodiment;

FIG. 15 is a top view of the seat shell with an insert shown as transparent coupled thereto according to an embodiment; and

FIG. 16 is a back view of the insert coupled to the seat shell and the insert engagement member received within the shell engagement member according to an embodiment.

### DETAILED DESCRIPTION

A detailed description of one or more embodiments of the disclosed apparatus and method are presented herein by way of exemplification and not limitation with reference to the Figures.

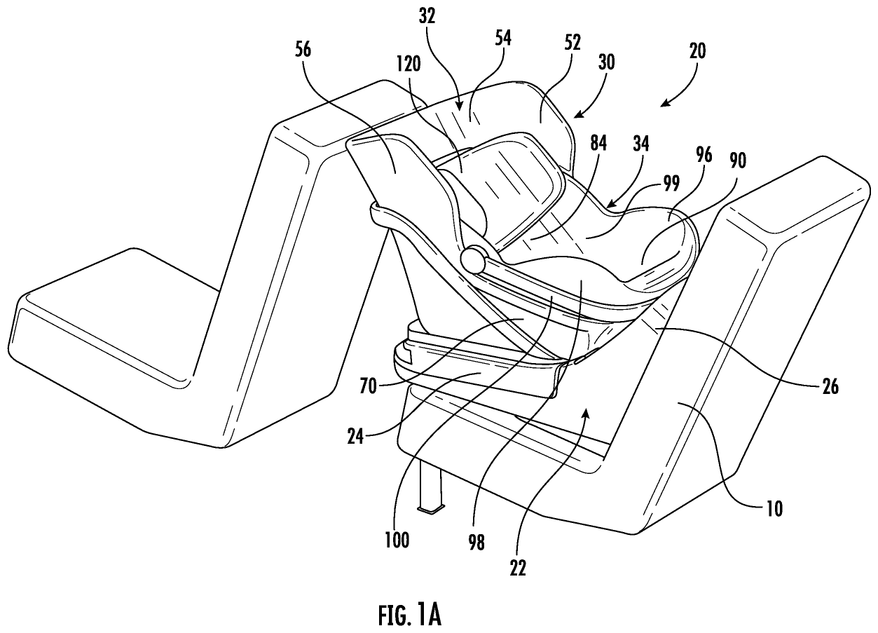

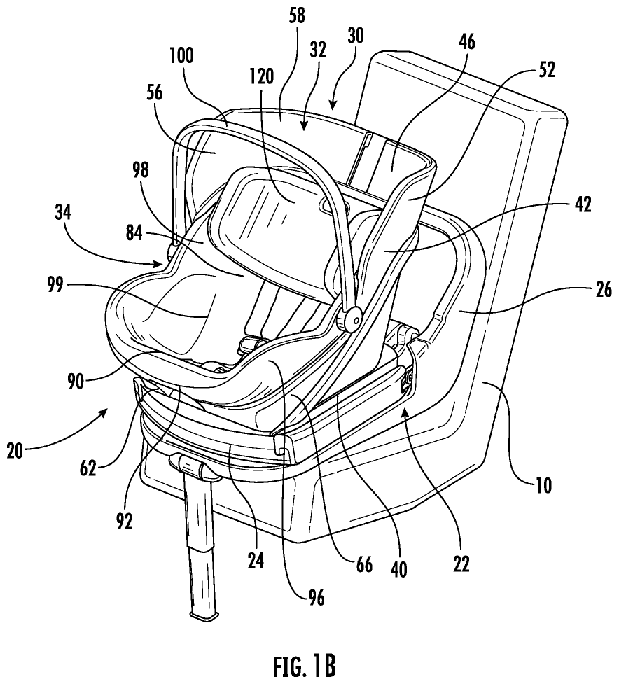

With reference now to FIGS. 1-3, a child safety seat 20 according to an embodiment is illustrated. The child safety seat 20 can be detachably fixed to a vehicle seat 10, such as via a latch or anchor mechanism (not shown). This latch or anchor system often used is sometimes referred to as a “lower anchor and tether for children” e.g., LATCH system. Alternatively, or in addition, the child safety seat 20 may be detachably fixed to a vehicle seat 10 via a vehicle belt (not shown) associated with the vehicle seat 10.

The child safety seat 20 may include a seat base 22 positionable in direct contact with a surface of the vehicle seat 10. In the illustrated, non-limiting embodiment, the seat base 22 includes a base seat assembly portion 24 and a base backrest portion 26 extending at an angle relative to the base seat assembly portion 24. However, embodiments where the seat base 22 has another configuration are also contemplated herein.

A seat body 30 may be mounted to the seat base 22. In an embodiment, the seat body 30 includes a seat shell 32 and an insert 34 arranged within the seat shell, as will be described in more detail below. At least a portion of the seat body 30, such as the insert 34 for example, may be removably connected to the seat base 22. Alternatively, at least a portion of the seat body 30 and the seat base 22 may be permanently connected or affixed together. For example, in an embodiment, the seat shell 32 may be permanently connected to the seat base 22. As used herein, the term “permanently connected” represents embodiments where the seat body is not intended to be disassembled from the seat base 22 by a user.

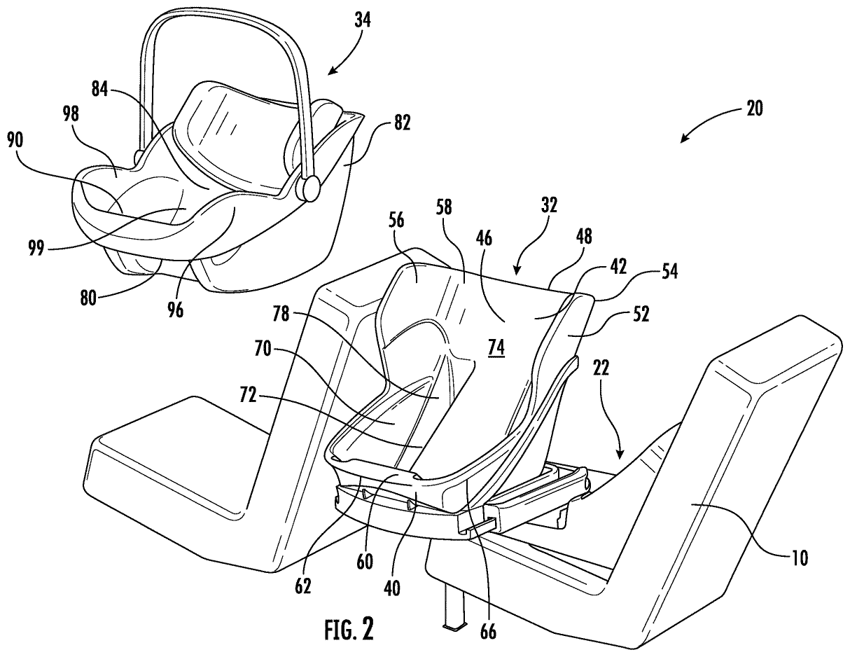

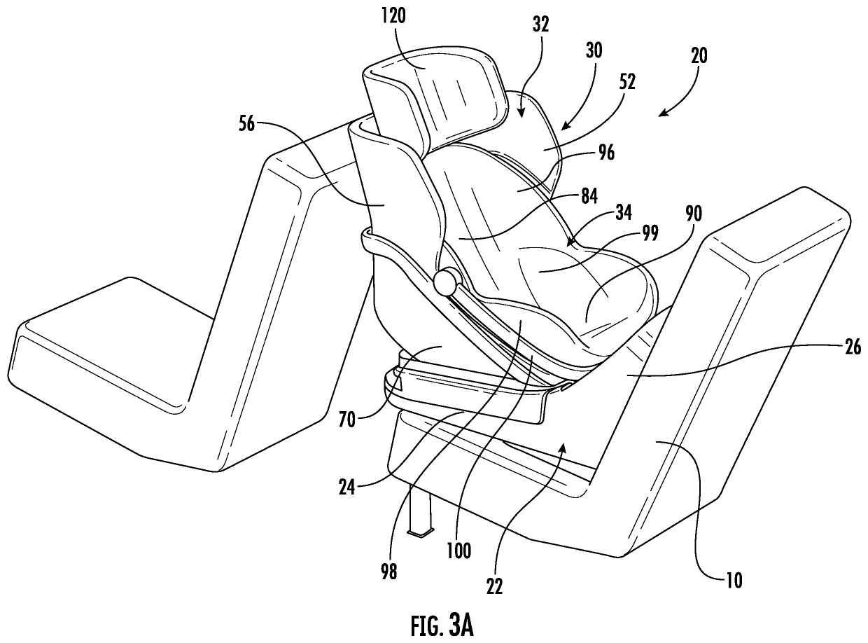

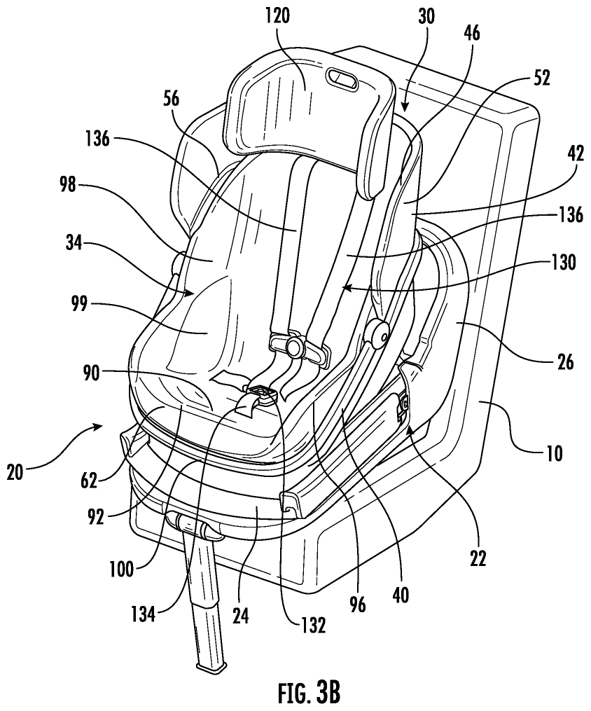

The seat body 30 may be rotatably coupled to the seat base 22. In an embodiment, the seat body 30, when connected to the seat base 22, is rotatable relative to the seat base 22 between a first, forward-facing position (see FIG. 1B and FIG. 3B) and a second, rearward-facing position (see FIG. 1A and FIG. 3A). It should be understood that the seat body 30 may be positionable at one or more positions disposed along the path of movement of the seat body 30 between the first position and the second position. For example, in the non-limiting embodiment illustrated in FIG. 2, the seat body 30 is rotatable to a third side-facing position disposed generally 90 degrees from both the first forward-facing position and the second rearward-facing position.

An example of a seat shell 32 is described herein in more detail. The seat shell 32 may include shell seat portion 40 and a shell backrest or upright portion 42 arranged at an angle relative to the shell seat portion 40. The shell seat portion 40 may be removably or permanently connected to the seat base 22. The shell seat portion 40 and the shell upright portion 42 may be detachably coupled, or alternatively, may be permanently coupled to one another. In the illustrated, non-limiting embodiment, the shell upright portion 42 and the shell seat portion 40 are integrally formed as a single unitary body, such as from a rigid or semi-rigid material. In another alternative embodiment, the shell upright portion 42 can be rotationally connected to the shell seat portion 40 such that the shell upright portion 42 can incline and recline relative to the shell seat portion 40.

The shell upright portion 42 of the seat shell 32 includes a shell upright support surface 46 generally facing forward and that extends from a first end or top 48 to a second, opposite end or bottom 50 (FIG. 9) thereof. A first shell upright side member 52 may be arranged at a first side 54 of the shell upright support surface 46 and a second shell upright side member 56 may be arranged at a second, opposite side 58 of the shell upright support surface 46. The first and second shell upright side members 52, 56 therefore form the left side and the right side of the shell upright portion 42, respectively. As shown, the first and second shell upright side members 52, 56 extend forward from the shell upright support surface 46. The first and second shell upright side members 52, 56 may extend generally orthogonally to the shell upright support surface 46, or alternatively, may extend therefrom at another angle, such as an angle greater than 90° for example.

The shell seat portion 40 includes a shell seat support surface 60 facing generally upwardly and that extends from a first end or front 62 to a second end or back 64 (see FIG. 9) of the shell seat portion 40. A first shell seat side member 66 may be arranged at a first side 68 (FIG. 9) of the shell seat support surface 60 and a second shell seat side member 70 may be arranged at a second, opposite side 72 of the shell seat support surface 60. The first shell seat side member 66 and the second shell seat side member 70 extend upwardly and form the left side and the right side of the shell seat portion 40.

As shown, the shell seat side members 66, 70 extend at an angle from the shell seat support surface 60. The angle of the first shell seat side member 66 relative to the shell seat support surface 60 may but need not be the same as the angle of the first shell upright side member 52 relative to the shell upright support surface 46. Similarly, the angle of the second shell seat side member 70 relative to the shell seat support surface 60 may but need not be the same as the angle of the second shell upright side member 56 relative to the shell upright support surface 46. In an embodiment, the first shell upright side member 52 and the first shell seat side member 66 are integrally formed and the second shell upright side member 56 and the second shell seat side member 70 are integrally formed.

The shell upright support surface 46 and the first and second shell upright side members 52, 56 define a backrest region or upright support cavity 74 within which an upper body of a child is generally received. Similarly, the shell seat support surface 60 and the first and second shell seat side members 66, 70 in combination define a seat region or seat cavity 76 within which at least part of a lower body of a child may be generally received. As shown, the upright support cavity 74 and the seat cavity 76 may be connected such that the two in combination form a single cavity 78 of the seat shell 32.

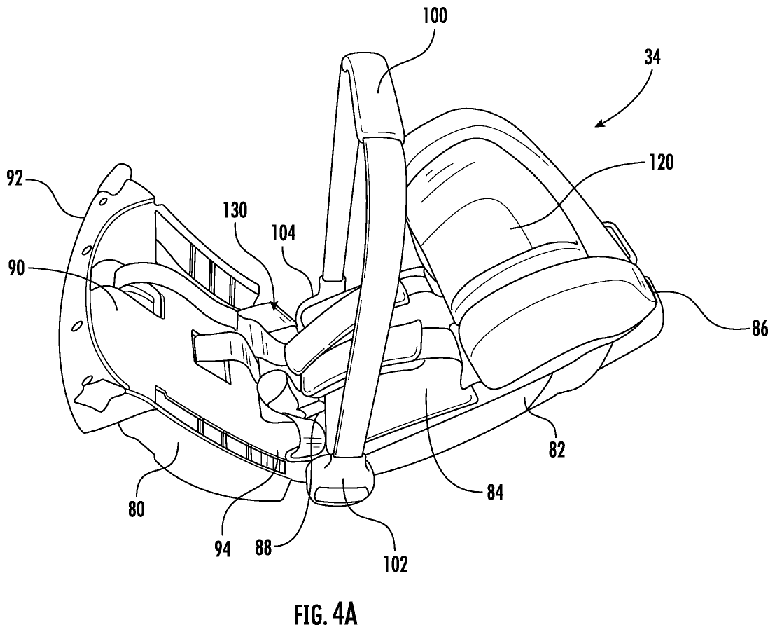

An insert 34 is receivable within the cavity 78. With reference now to FIGS. 4A-6, an example of an insert 34 of the seat body 30 is illustrated in more detail. As shown, the insert 34 includes a body having an insert seat portion 80 and an insert backrest or upright portion 82 arranged at an angle relative to the insert seat portion 80. The insert seat portion 80 and the insert upright portion 82 may be detachably coupled, or alternatively, may be permanently coupled to one another. In an embodiment, the insert upright portion 82 is rotationally connected to the insert seat portion 80 such that the insert upright portion 82 can incline and recline relative to the insert seat portion 80. However, embodiments where the insert upright portion 82 and the insert seat portion 80 are fixed relative to one another are also contemplated herein. In such embodiments, the insert upright portion 82 and the insert seat portion 80 may be integrally formed as a single unitary body, such as from a rigid or semi-rigid material.

The insert upright portion 82 includes an insert upright support surface 84 generally facing forward and that extends from a first end or top 86 to a second, opposite end or bottom 88 of the insert upright portion 82. The insert seat portion 80 similarly includes an insert seat support surface 90 facing generally upwardly and that extends from a first end or front 92 to a second end or back 94 of the insert seat portion 80. When connected to the insert 34, a child may be located such that the upper body of the child is positioned in contact with the insert upright support surface 84 and the lower body of the child is positioned in contact with the insert seat support surface 90.

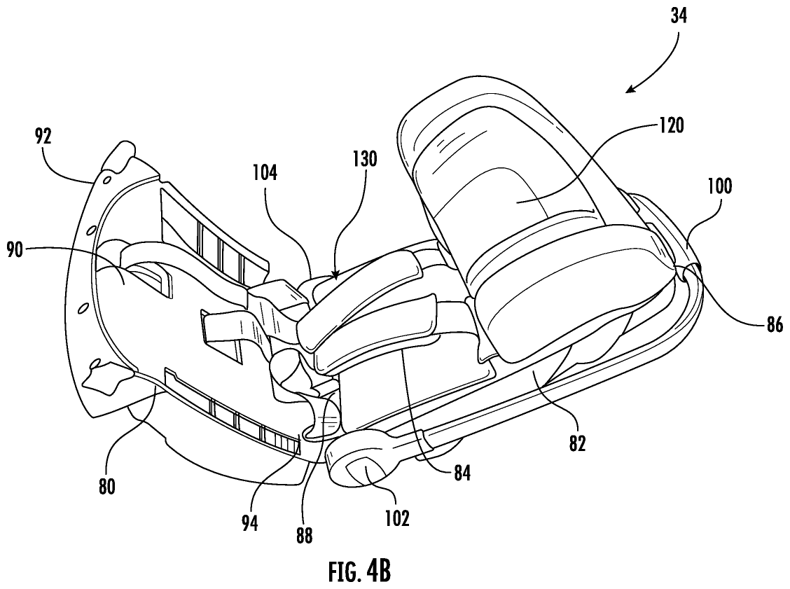

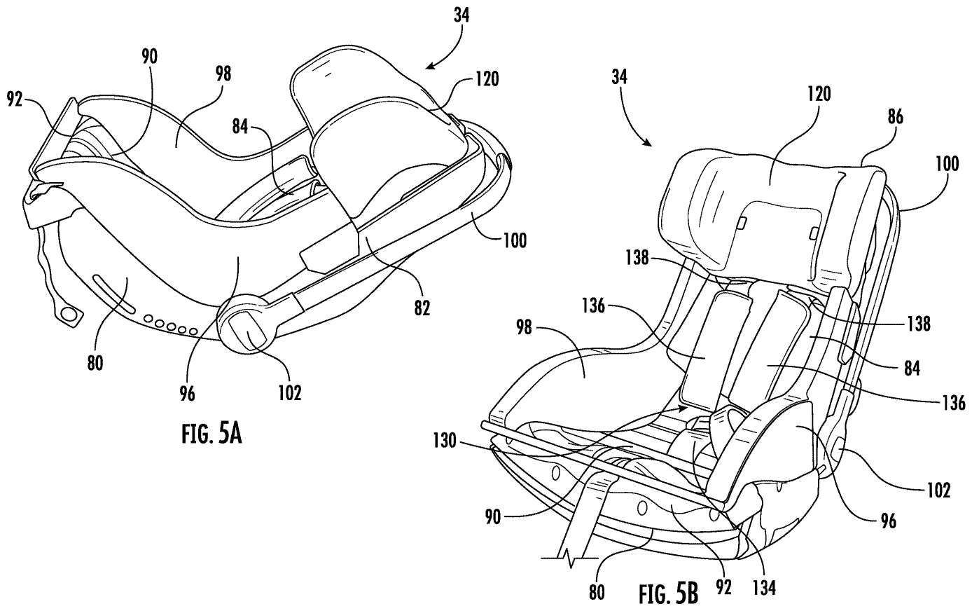

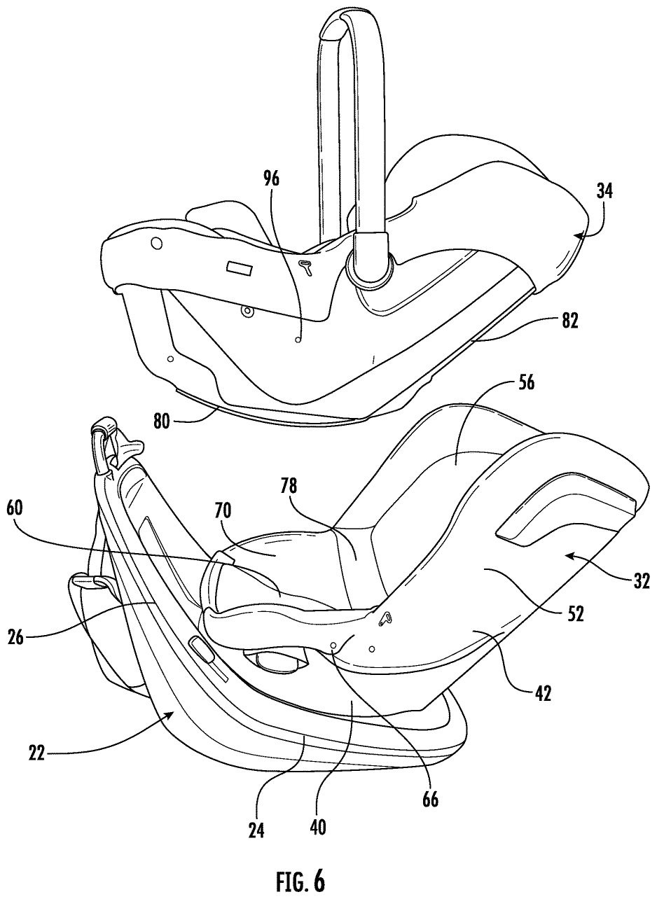

The insert 34 is transformable between an infant configuration (also referred to herein as an infant seat) and a toddler configuration (also referred to herein as a toddler seat). With reference to FIGS. 5A and 5B, when the insert 34 is in the infant configuration, at least one sidewall may be arranged at one or more sides of the body of the insert 34. For example, a first sidewall 96 may be arranged adjacent to a first side of one or both of the insert upright portion 82 and the insert seat portion 80 and a second sidewall 98 may be arranged adjacent to a second, opposite side of one or both of the insert upright portion 82 and the insert seat portion 80. In such embodiments, the plurality of sidewalls 96, 98 arranged at the left and right sides of the insert 34 may be formed from a soft material, such as a fabric for example. In embodiments of the insert 34 including the sidewalls 96, 98, the sidewalls cooperate with the insert seat portion 80 and the insert upright portion 82 to form an insert cavity 99 within which an infant is receivable. An insert 34 having a first and second sidewall 96, 98, such as shown in FIG. 6, may be similar to an infant carrier suitable for use not only in the child safety seat 20, but also as an attachment to a stroller or other travel device.

In an embodiment, the plurality of sidewalls 96, 98 are removably connectable with the body of the insert 34. For example, to adapt the insert 34 to a toddler configuration suitable for use with an older child, the sidewalls 96, 98 may be removed from the insert 34 to provide more room for the child within cavity 78 of the seat shell 32. When the sidewalls 96, 98 are removed, the first shell seat side member 66 and the second shell seat side member 70 of the seat shell 32 can act as sidewalls for the toddler configuration to help position and retain the older child within the insert 34. The first and second shell seat side members 66 and 70 can include soft goods for child comfort. However, embodiments where the insert does not include sidewalls 96, 98 when in the infant configuration and/or embodiments where the insert 34 includes sidewalls 96, 98 when in the toddler configuration are also contemplated herein.

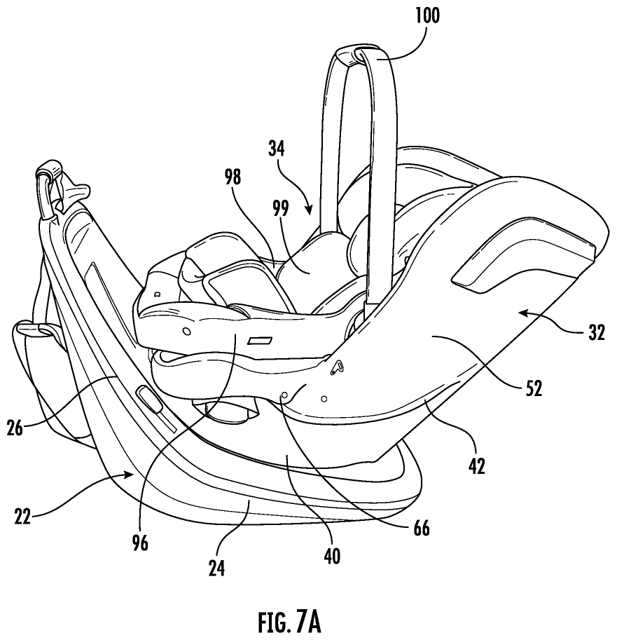

Further, for the insert 34 to be operable as a carrier when disconnected or separated from the seat shell 32, the insert 34 may include a carrying handle 100. In the illustrated, non-limiting embodiment, the carrying handle 100 has an arc shape and the two opposite ends 102, 104 thereof are respectively connected with a left and right side of the insert body. The carrying handle 100 may be pivotally connected with the body of the insert 34. Accordingly, the carrying handle 100 may be transformable between a plurality of angular positions relative to the insert 34. Examples of the angular positions include when the carrying handle 100 extends within a vertical plane (FIGS. 4A and 7A), also referred to herein as a “carrying position”, when the carrying handle 100 is reclined rearwardly, such as behind the insert upright portion 82 (FIG. 4B) for example, and when the carrying handle 100 is rotated forward to a position disposed adjacent to the front 92 of the insert seat support surface 90 (FIG. 7B). In an aspect, the carrying handle 100 can be rotated toward the front 92 such that the carrying handle 100 is below the insert seat support surface 90 (e.g., a stored position). The position of the carrying handle 100 below the insert seat support surface 90 can prevent feet of a child positioned in the insert 34 from being obstructed by the carrying handle 100. It should be understood that the carrying handle 100 may also be arranged at other angular positions along the path of movement of the carrying handle 100.

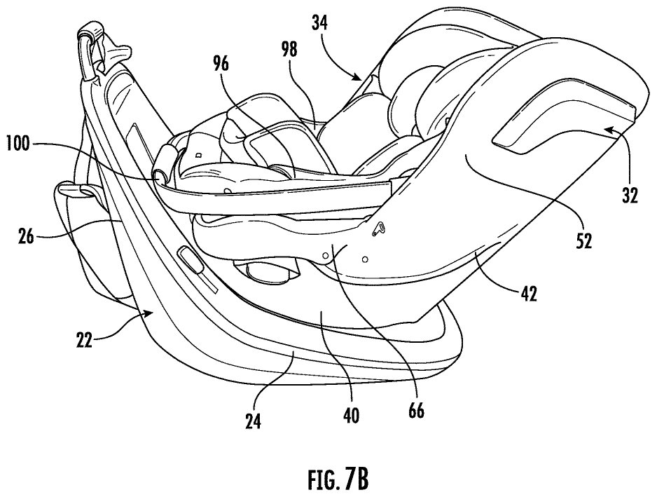

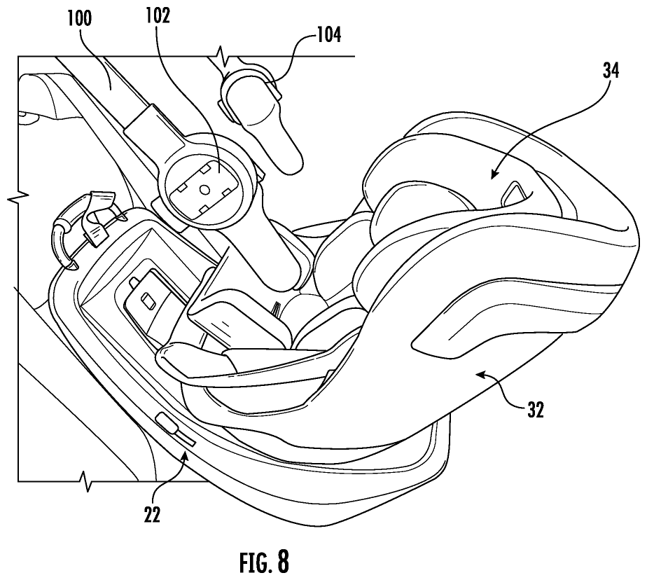

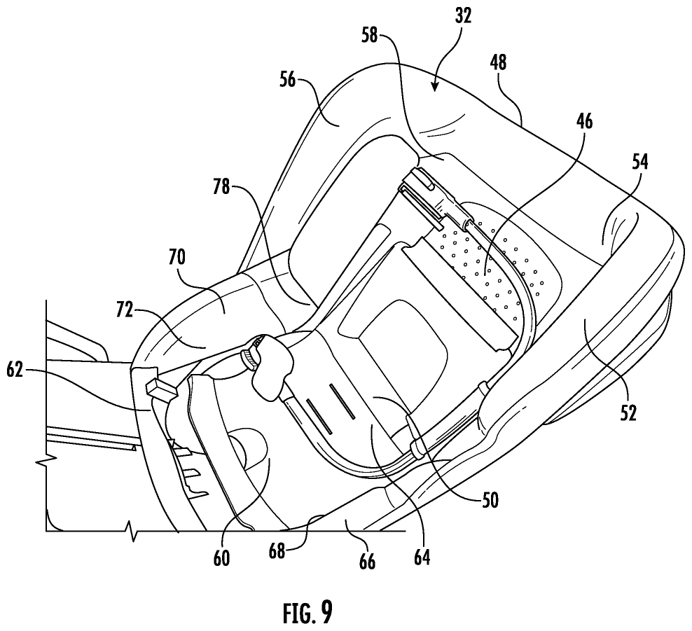

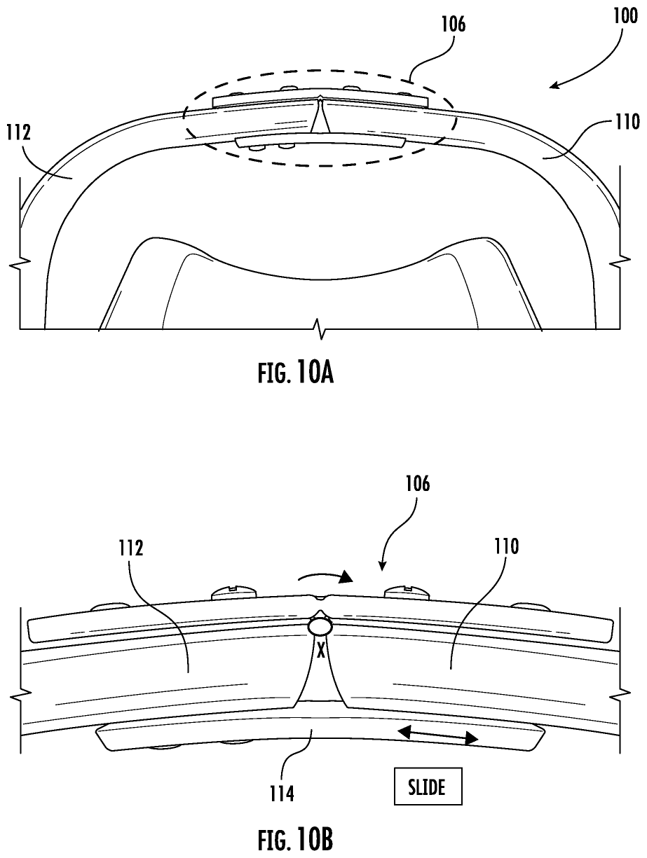

In an embodiment, best shown in FIG. 8, the carrying handle 100 may be releasably connected to the body of the insert 34. Any suitable mechanism for selectively coupling the carrying handle 100 to the insert 34 is contemplated herein. In an embodiment, the carrying handle 100, separated from the insert 34, may be stowed within the cavity 78 of the seat shell 32 between the seat shell 32 and the insert 34 (see FIG. 9). In an embodiment, the carrying handle 100 is transformable to a collapsed configuration prior to installation within the seat shell 32. With reference to FIGS. 10A and 10B, in an embodiment, a flexible region 106 may be formed in the carrying handle 100, such as near a center thereof for example. The flexible region 106 may define a hinge axis X about which a first portion 110 of the carrying handle 100 may flex or bend relative to the second portion 112 of the carrying handle 100. In the illustrated, non-limiting embodiment, a rigid connector 114 is slidably coupled to the carrying handle 100 adjacent to the flexible region 106. When the rigid connector 114 is in overlapping arrangement with the flexible region 106, and specifically the axis X thereof (as shown in FIG. 10B), relative movement between the first and second portions 110, 112 of the carrying handle 100 about the axis X is restricted. Accordingly, the carrying handle 100 is locked in an extended or use configuration. When the rigid connector 114 is moved, for example translated or rotated out of alignment with the axis X, the first portion 110 of the carrying handle 100 is free to pivot about the axis X relative to the second portion 112. This relative movement allows the carrying handle 100 to transform to the collapsed configuration where at least one dimension of the carrying handle 100 is reduced compared to when the carrying handle 100 is in the use position.

In the illustrated, non-limiting embodiment, the insert upright portion 82 includes a headrest 120. The headrest 120 is attached to or integral with the insert upright portion 82. The headrest 120 may be stationary, or in some embodiments, may be configured to move relative to the insert upright support surface 84. For example, the headrest 120 may be configured to translate vertically relative to the insert upright support surface 84 between a retracted position (FIG. 1A, 1B) and an extended position (FIG. 3A, 3B), allowing for adjustment based on the size of the child positioned within the child safety seat 20. In an embodiment, the headrest 120 is in a lowered or retracted position when the insert 34 is in the infant configuration, and the headrest 120 is raised relative to the insert upright support surface 84 when the insert 34 is in the toddler configuration.

The insert 34 receivable within the cavity 78 of the seat shell 32 may include a restraint harness 130 for restraining a child positioned on the insert 34. The restraint harness 130, best shown in FIG. 5B, may include multiple harness straps, including but not limited to shoulder straps, waist straps, and a crotch strap. A buckle may be connected to one of the harness straps and may be operable to couple the plurality of harness straps together. In an embodiment, the buckle 132 is attached to an end of the crotch strap 134 and is operable to attach the shoulder straps 136 and/or the waist straps (not shown) to the crotch strap 134 to restrict movement of the body of a child relative to the insert 34.

In embodiments of the restraint harness 130 including one or more shoulder straps 136, each shoulder strap 136 may extend through a respective slit 138 formed in the insert upright support surface 84, or alternatively, in a portion of the headrest 120. In embodiments where the shoulder straps 136 extends through slits 138 formed in the headrest 120, the restraint harness 130 is operably coupled to the headrest 120. Accordingly, when the headrest 120 is at a lowered position relative to the insert upright support surface 84, such as to accommodate an infant or smaller child, part of the shoulder straps 136 are exposed beneath the headrest 120, adjacent to the insert upright support surface 84, and another part of the shoulder straps 136 are hidden within an interior of the body of the insert 34. Similarly, when the headrest 120 is raised relative to the insert upright support surface 84 to accommodate a taller child, the part of the shoulder straps 136 exposed beneath the headrest 120 is increased relative to when the headrest 120 is lowered and the part of the shoulder straps 136 hidden within the body of the insert 34 is reduced relative to when the headrest 120 is lowered. As a result, the length of the shoulder straps 136 is adjustable with the headrest 120 to adapt to the size of the child positioned on the insert 34.

As best shown in FIGS. 2 and 6, the insert 34 is receivable within the cavity 78 of the seat shell 32. The insert 34 may be connectable to the seat shell 32 when in either the infant configuration or the toddler configuration. When installed within the cavity 78, the insert seat portion 80 is arranged adjacent to and may be disposed in overlapping arrangement with the shell seat support surface 60 and the insert upright portion 82 is arranged adjacent to and may be in overlapping arrangement with the shell upright support surface 46. In an embodiment, the insert 34 is configured to mechanically couple to the seat shell 32 when installed within the cavity 78. For example, the insert 34 may include a first portion of at least one coupling mechanism and a complementary second portion of the at least one coupling mechanism may be arranged at an adjacent surface of the seat shell 32, such as at the shell seat support surface 60 and/or the shell upright support surface 46 for example.

Because the restraint harness 130 is associated with the removable insert 34 and not the seat shell 32, it should be appreciated that a child cannot be properly seated in the child safety seat 20 when the insert 34 is not installed on the seat shell 32. As noted above, the insert 34 is transformable between an infant configuration and a toddler configuration to transform the seat body 30 between an infant seat and a toddler seat, such as by adjusting a position of the headrest and/or adding or removing the sidewalls 96, 98 relative to the body of the insert 34. However, the restraint harness 130 remains affixed to the insert 34 regardless of the configuration thereof. Accordingly, the same restraint harness 130 affixed to the insert 34 is operable to secure a child to the seat body 30 when the seat body 30 of the child safety seat 20 is configured as an infant seat and when the seat body 30 of the child safety seat 20 is configured as a toddler seat. In addition, a child may be easily separated from a vehicle seat 10 by simply removing the insert 34 from the seat shell 32 while the child remains attached to the insert 34 via the restraint harness 130. In this manner, the insert 34 can also function as a child carrier when separated from the remainder of the child safety seat 20.

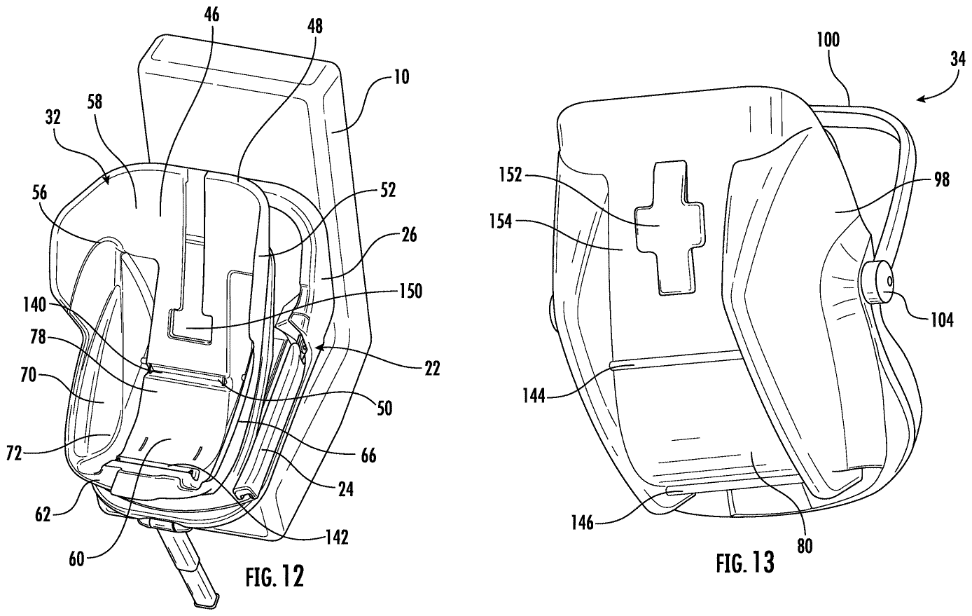

As previously described, the insert 34 is removably receivable within the cavity 78 of the seat shell 32. With reference now to FIGS. 12 and 13, in an embodiment, the seat shell 32 includes at least one groove, such as a first groove 140 and a second groove 142 spaced apart from one another for example. The first and second grooves 140, 142 can be formed as recesses in the shell seat support surface 60 or one or more other suitable surfaces of the seat shell 32. Each of these grooves 140, 142 may be sized to receive and retain a seat connector 144, 146, such as a shaft arranged at a bottom surface of the insert 34 for example. Although not shown, it should be appreciated that each of the first and second grooves 140, 142 can include a catch with which a corresponding latch (not shown) can engage the seat connectors 144, 146 to lock the insert 34 to the seat shell 32.

Alternatively, or in addition, the seat shell 32 may include at least one shell engagement member 150 and the insert 34 may include at least one corresponding insert engagement member 152 connectable to the shell engagement member 150 to couple the insert 34 to the seat shell 32. When the insert engagement member 152 and the shell engagement member 150 are coupled, the connection formed between the connection between the seat shell 32 and the insert 34 further stabilizes the back portion of the seat body 30. In the illustrated, non-limiting embodiment, the shell engagement member 150 is shown as being arranged at the shell upright support surface 46 of the shell upright portion 42 and the insert engagement member 152 is illustrated as being located at a back surface 154 of the insert upright portion 82 or the headrest 120. However, embodiments where the engagement members 150, 152 are located at any adjacent surface of the seat shell 32 and insert 34 are contemplated herein are also contemplated herein.

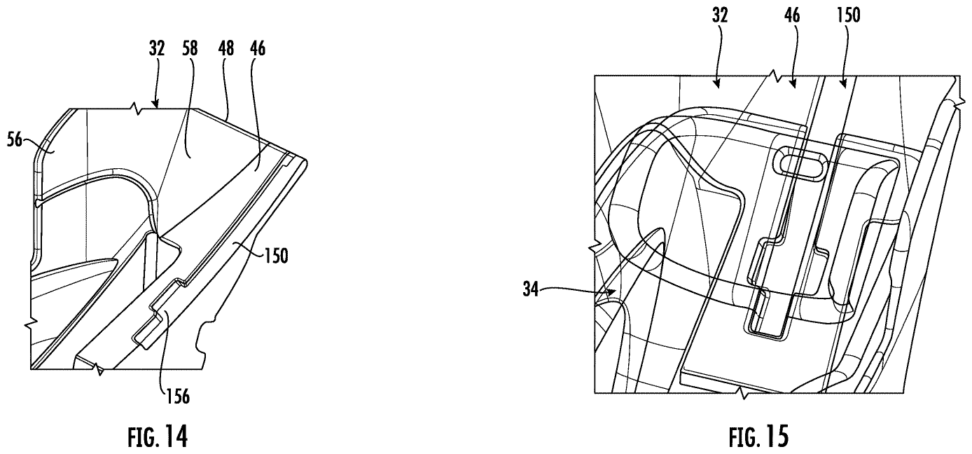

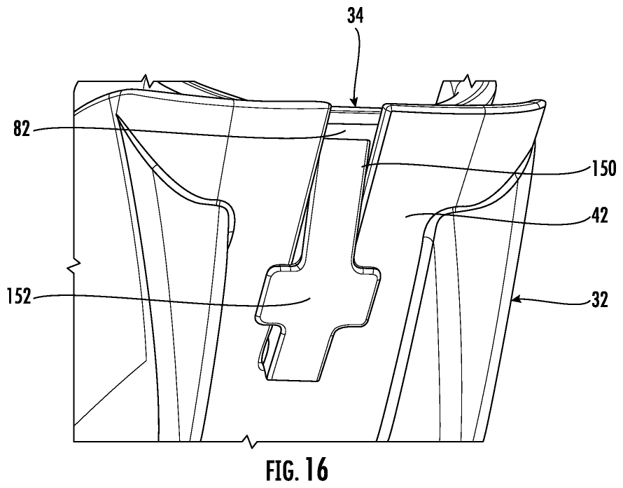

In the illustrated, non-limiting embodiment, the shell engagement member 150 includes a channel or track extending downwardly from the top 48 of the shell upright support surface 46. In such embodiments, the insert engagement member 152 may include a rib or protrusion slidably receivable within the channel or track. Such a configuration is intended to facilitate engagement between the shell engagement member 150 and the insert engagement member 152 over a range of positions of the insert engagement member 152 as the insert 34 transforms or is expanded for use with a growing child. In the illustrated, non-limiting embodiment, best shown in FIGS. 13 and 16, the insert engagement member 152 has a T-shaped configuration when viewed from a back surface of the insert upright portion 82. The channel 150 configured to receive the T-shaped insert engagement member 152 may have a uniform configuration over its length, or alternatively, may have a configuration that varies over its length. In an embodiment, as shown in the cross-sectional view of FIG. 14, a contoured groove 156 having a size and shape complementary to the shape of the insert engagement member 152 may be arranged at a desired position relative to the channel 150, such as at or near and end of the channel 150 for example. The position of the groove 156 may be located to properly arrange the insert 34 relative to the seat shell 32. Although the channel 150 is described as being formed in the seat shell 32 and the protrusion 152 receivable therein is illustrated and described as extending from the insert 34, it should be understood that embodiments where the channel 150 is formed at the insert 34 and the protrusion 152 extends from the seat shell 32 are also within the scope of the disclosure.

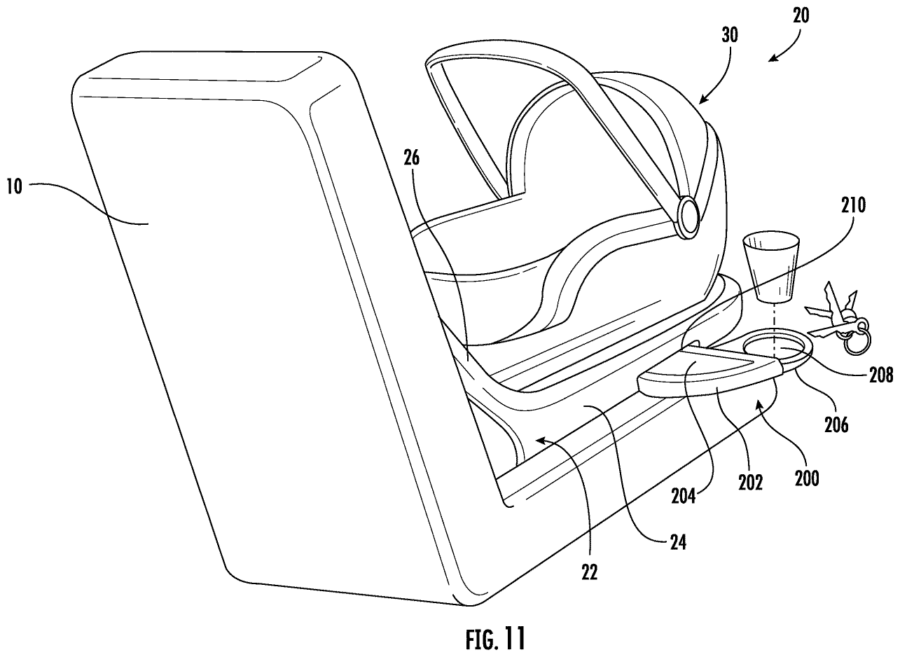

With reference now to FIG. 11, in an embodiment, the child safety seat 20, such as the seat base 22 thereof for example, includes one or more accessories 200 for storing one or more belongings when loading or unloading a child into the child safety seat 20. Although the accessory 200 illustrated in the FIG. is located at the seat portion 24 of the seat base 22, it should be understood that in other embodiments the accessory 200 may be located at the upright portion 26 of the seat base 22. Alternatively, or in addition, an accessory 200 may be located at the seat body 30.

In an embodiment, the accessory 200 includes a tray 202 having a recessed area 204 for receiving items such as keys, a phone, a wallet, or other items commonly in a parent's hand during ingress and egress of a vehicle. Alternatively, or in addition, the accessory 200 may include a cup holder 206 having an opening 208 sized to receive a standard size cup, bottle or can. Although the opening 208 of the cup holder 206 is illustrated as having a fixed diameter, embodiments where the opening 208 of the cup holder 206 is adjustable are also contemplated herein.

The accessory 200 may be transformable, for example translatable or pivotable, between an extended configuration (shown in the FIG.) and a retracted configuration (not shown). In the retracted configuration, the substantial entirety of the accessory 200 is received within an opening or pocket 210 formed in the seat base 22. In an embodiment, when the accessory 200 is in the retracted configuration, an edge or end of the accessory 200 is substantially flush with the adjacent surface of the seat base 22 to provide an aesthetically pleasing appearance and to minimize interference with access to the child safety seat 20. The accessory 200 may be transformable between the retracted configuration and the extended configuration in response to application of an inward force to the exposed end or edge of the accessory 200. When an inward force is applied to the edge of the accessory 200 positioned flush with the adjacent portion of the seat base 22, the accessory 200 may move outwardly to the extended configuration. Similarly, application of an inward force to the same edge of the accessory 200 when in the extended configuration will cause the accessory 200 to move into the opening 210 formed in the seat base 22.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A child safety seat for placement on a vehicle seat, the child safety seat comprising:
a seat base; and
a seat body associable with said seat base, said seat body being configurable as both an infant seat and a toddler seat;
a restraint harness associated with said seat body, said restraint harness being operable when said seat body is configured as both said infant seat and said toddler seat.

2. The child safety seat of claim 1, wherein said seat body further comprises:
a seat shell affixed to said seat base; and
a seat insert removably connectable to said seat shell.

3. The child safety seat of claim 2, wherein said restraint harness is affixed to said seat insert.

4. The child safety seat of claim 3, wherein said seat insert is separable from said seat shell when said child is coupled to said seat insert by said restraint harness.

5. The child safety seat of claim 3, wherein said seat insert further comprises a headrest, said headrest being movable between a first position associated with said infant seat and a second position associated with said toddler seat.

6. The child safety seat of claim 5, wherein said restraint harness is operably coupled to said headrest.

7. The child safety seat of claim 3, wherein said seat insert further comprises:
a body including an insert seat portion and an insert upright portion; and
at least one sidewall, said at least one sidewall being connectable to a side of said body.

8. The child safety seat of claim 7, wherein when said seat body is configured as said infant seat, said at least one sidewall is connected to said body and when said seat body is configured as said toddler seat, said at least one sidewall is separated from said body.

9. The child safety seat of claim 2, wherein said seat body further comprises:
an insert seat support surface on said seat insert for supporting a child thereon; and
a carrying handle rotatably connected to said seat insert, said carrying handle being rotatable between a carrying position and a stored position, wherein in said stored position said carrying handle is positioned below said insert seat support surface.

10. The child safety seat of claim 1, wherein said seat body is positionable relative to said seat base in both a forward-facing position and a rearward-facing position.

11. The child safety seat of claim 10, wherein said seat body is positionable relative to said seat base at a position between said forward-facing position and said rearward-facing position.

12. An infant seat of a child safety seat, the infant seat comprising:
a seat body including:
a seat shell; and
a seat insert removably connectable to said seat shell, said seat insert having a body and a restraint harness coupled to said body.

13. The infant seat of claim 12, wherein said seat shell further comprises a cavity and said seat insert is positionable within said cavity.

14. The infant seat of claim 13, wherein said seat insert further comprises a plurality of sidewalls connected to said body to define an insert cavity within which a child is receivable.

15. The infant seat of claim 14, wherein said body and said plurality of sidewalls of said infant seat are positionable within said cavity.

16. The infant seat of claim 14, wherein said seat insert is separable from said seat shell when said child is coupled to said seat insert by said restraint harness.

17. The infant seat of claim 16, wherein said seat insert is an infant carrier when separated from said seat shell.

18. The infant seat of claim 12, wherein said seat insert is transformable to a toddler configuration.

19. A toddler seat of a child safety seat, the toddler seat comprising:
a seat body including:
a seat shell; and
a seat insert removably connectable to said seat shell, said seat insert having a body and a restraint harness coupled to said body.

20. The toddler seat of claim 19, wherein said seat shell further comprises a cavity and said seat insert is positionable within said cavity.

21. The toddler seat of claim 19, wherein said seat insert further comprises a plurality of sidewalls removably connectable to said body, said plurality of sidewalls being separated from said body.

22. The toddler seat of claim 19, wherein said seat insert is separable from said seat shell when a child is coupled to said seat insert by said restraint harness.

23. The infant seat of claim 19, wherein said seat insert is transformable to an infant configuration.

24. A method of operating a child safety seat comprising:
positioning a seat shell relative to a seat base;
arranging a seat insert in one of an infant configuration and a toddler configuration; and
connecting said seat insert to said seat shell.

25. The method of claim 24, wherein positioning said seat shell relative to said seat base further comprises rotating said seat shell between a forward-facing position and a rearward-facing position.

26. The method of claim 24, wherein arranging said seat insert further comprises adjusting a position of a headrest of said seat insert, wherein in said infant configuration, said headrest is lowered relative to said seat insert and in said toddler configuration, said headrest is raised relative to said seat insert.

27. The method of claim 24, wherein arranging said seat insert further comprises adjusting a position of at least one sidewall of said seat insert, wherein in said infant configuration, said at least one sidewall is attached to said seat insert and in said toddler configuration, said at least one sidewall is separated from said seat insert.

28. The method of claim 24, further comprising coupling a child to said seat insert via a restraint harness of said seat insert.

29. The method of claim 28, wherein said restraint harness is operable to couple said child to said seat insert when said seat insert is in both said infant configuration and said toddler configuration.

30. The method of claim 24, wherein connecting said seat insert to said seat shell further comprises positioning said seat insert within a cavity of said seat shell.

31. The method of claim 24, wherein connecting said seat insert to said seat shell further comprises connecting a first portion of a coupling mechanism mounted to said seat insert to a complementary second portion of said coupling mechanism mounted to said seat shell.

32. The method of claim 24, further comprising adjusting a position of a carrying handle of said seat insert.

33. The method of claim 32, wherein adjusting said position of said carrying handle further comprises rotating said carrying handle about an axis relative to said seat insert.

34. The method of claim 32, wherein adjusting said position of said carrying handle further comprises separating said carrying handle from said seat insert.

35. A child safety seat for placement on a vehicle seat, the child safety seat comprising:
a seat base;
a seat body associated with said seat base; and
an accessory associated with one of said seat base and said seat body, said accessory being transformable between a retracted configuration and an extended configuration, wherein in said retracted configuration, said accessory is stowed within a pocket formed in said one of said seat base and said seat body.

36. The child safety seat of claim 35, wherein said accessory is pivotable about an axis between said retracted configuration and said extended configuration.

37. The child safety seat of claim 35, wherein said accessory is translatable between said retracted configuration and said extended configuration.

38. The child safety seat of claim 35, wherein said accessory further comprises a tray having a recessed area formed therein.

39. The child safety seat of claim 35, wherein said accessory further comprises a cup holder.

40. The child safety seat of claim 35, wherein in said retracted configuration, said accessory is substantially flush with an adjacent surface of said one of said seat base and said seat body.
